(19) United States
(12) Patent Application Publication
(10) Pub. No.: US 2004/0179596 A1
(43) Pub. Date: Sep. 16, 2004

(54) Method and apparatus for encoding video signal with variable bit rate

(75) Inventors: Byung-cheol Song, Suwon-si (KR); Kang-wook Chun, Hwaseong-gun (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/687,589

(22) Filed: Oct. 20, 2003

(30) Foreign Application Priority Data
Feb. 24, 2003 (KR) 2003-11344

(51) Int. Cl. H04N 7/12

(52) U.S. Cl. 375/240.03

(57) ABSTRACT

A method and apparatus for encoding a video signal with a variable bit rate are provided. The method for encoding the video signal with the variable bit rate includes: (a) calculating a complexity for each of a plurality of pictures on the basis of a bit amount and a quantization parameter of a previous frame; (b) calculating a remaining bit amount for each picture in proportion to the complexity for each picture calculated in (a); (c) calculating a quantization parameter of a current frame on the basis of the complexity for each picture and the remaining bit amount for each picture calculated in (b); and (d) comparing the quantization parameter of the current frame calculated in (c) with a predetermined minimum quantization parameter and determining a final quantization parameter.

This application claims the priority of Korean Patent Application No. 2003-11344, filed on Feb. 24, 2003, in the Korean Intellectual Property Office, the disclosure of which is incorporated herein in its entirety by reference.

### BACKGROUND OF THE INVENTION

1. Field of the Invention

The present invention relates to moving-picture compression techniques, and more particularly, to a method and apparatus for encoding a video signal with a variable bit rate.

2. Description of the Related Art

Generally, a bit amount generated by a moving-picture encoder is not the same for every picture and every macroblock in a picture, according to characteristics of input images. To transmit such irregularly generated data at a constant transmission rate while maintaining high picture quality, bit rate control is required. For performing this bit rate control, the TM5 of the MPEG-2 defines a Constant Bit Rate (CBR) method and a Variable Bit Rate (VBR) method.

First, the CBR method is a method that allocates a common bit amount of a Group Of Picture (GOP) unit to achieve a fixed bit amount, wherein the bit amount for the GOP has a constant value in a whole sequence. Meanwhile, the VBR method maintains uniform picture quality for all pictures. Accordingly, the VBR method is aimed at maintaining a quantization parameter value QP, which is a measurement of picture quality, as uniform as possible. The VBR method modifies a bit rate for every GOP. The VBR method is generally classified into a two-pass VBR method and a one-pass VBR method. For example, the two-pass VBR method first encodes an image sequence using CBR and obtains a complexity for each picture. The complexity of an i-th picture is defined by the following Equation 1.

X[i]=R[i]×QP_{avg}[i] (1)

Here, X[i] is the complexity of the i-th picture, R[i] is an i-th bit amount, and QP_{avg}[i] is an average quantization parameter QP of the i-th picture.

Complexities of all pictures are calculated using the CBR method, and then, the VBR method is performed using an original image signal. A quantization parameter QP for a frame is obtained by dividing an average complexity value by an average bit rate. The VBR method is performed using this quantization parameter QP. However, because the two-pass VBR method requires two encoders or requires two encoders or two encoding processes, the amount of calculation increases and complicated hardware is needed. For this reason, the one-pass VBR method was developed. FIG. 1 shows an example of a one-pass VBR apparatus, which is disclosed in “A scene-adaptive one-pass variable bit rate video coding method for storage media” by Y. Yokoyama and Y. Ooi, IEEE International Conference on Image Processing (ICIP), pp. 827-831, 1999. However, the one-pass VBR method cannot obtain the average complexity for entire image signals, while the two-pass VBR method can. The one-pass VBR method merely estimates the average complexity using pixel information up to a current time.

Referring to FIG. 1, a complexity calculator 110 obtains an average complexity of a GOP unit on the basis of an input bit amount and quantization parameters. At this time, it is assumed that an average complexity of the previous GOP is X_{gop} and an average complexity for all frames up to the previous GOP is X_{avg}. A QP calculator 120 sets a quantization parameter QP of a GOP adaptively for every picture under the assumption that the X_{avg} is an average complexity of entire images. That is, a quantization parameter value QP_{gop} of a current GOP is calculated by equation 2.

QP_{gop}=min(X_{avg}·X_{gop})/R_{avg} (2)

Here, R_{avg} is an average bit amount for each picture and is obtained when a target bit rate for whole frames is set.

If X_{avg} is smaller than X_{gop}, an average quantization parameter QP up to a current frame is used as a quantization parameter QP of a current frame. If X_{avg} is greater than X_{gop}, an average quantization parameter QP of the previous GOP is used as the quantization parameter QP of the current frame.

An average bit rate controller 130 adjusts an average bit rate using the quantization parameter QP of the GOP calculated by the QP calculator 120.

A QP selector 150 compares QP_{gop} generated by the average bit rate controller 130 with QPₘᵢₙ set by a minimum quantization parameter (QPₘᵢₙ) setting unit 140, and decides a final quantization parameter (QP).

Accordingly, in the one-pass VBR method shown in FIG. 1, a final target bit rate is frequently not obtained since either one of X_{avg} and X_{gop} is selected. In most cases, the one-pass VBR method has a problem of the obtained bit rate being significantly greater than a target bit rate.

### SUMMARY OF THE INVENTION

The present invention provides a method and apparatus for encoding a video signal with a variable bit rate, capable of approaching a target bit amount by deciding a quantization parameter based on a remaining bit amount in a one-pass VBR method.

According to an aspect of the present invention, there is provided a method for encoding a video signal with a variable bit rate, the method comprising: (a) calculating a complexity for each of a plurality of pictures on the basis of a bit amount and a quantization parameter of a previous frame; (b) calculating a remaining bit amount for each picture in proportion to the complexity for each picture calculated in (a); (c) calculating a quantization parameter of a current frame on the basis of the complexity for each picture and the remaining bit amount for each picture calculated in (b); and (d) comparing the quantization parameter of the current frame calculated in (c) with a predetermined minimum quantization parameter and determining a final quantization parameter.

According to another aspect of the present invention, an apparatus for encoding a video signal includes: a discrete cosine transform (DCT) unit which performs DCT on input image data in units of macroblocks; a bit rate controller which determines a quantization parameter of a current frame, on the basis of a bit amount for each picture and a complexity for each picture generated per frame; a quantization unit which quantizes the image data subjected to DCT by the DCT unit according to the quantization parameter determined by the bit rate controller; a dequantization unit which dequantizes the image data quantized by the quantization means; an Inverse Discrete Cosine Transform (IDCT) unit which performs IDCT on the image data dequantized by the dequantization unit; a frame memory which stores the image data subjected to IDCT by the IDCT unit, in units of frames; and a movement estimation and compensation unit which estimates a movement vector and a Sum of Absolute Difference (SAD) using image data of an input current frame and image data of an immediately proceeding frame stored in the frame memory, and compensates for movement using the movement vector.

The bit rate controller comprises: a complexity calculator which calculates the complexity for each picture on the basis of the bit amount of each frame in the picture and the quantization parameters; a remaining bit amount calculator which calculates a remaining bit amount for each picture in proportion to the complexity calculated by the complexity calculator; and a quantization parameter determination unit which determines the quantization parameter on the basis of the complexity for each picture and the remaining bit amount for each picture calculated by the complexity calculator and the remaining bit amount calculator.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a one-pass VBR apparatus;

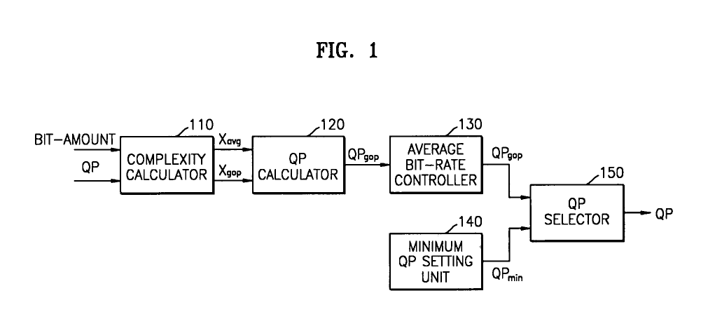

FIG. 2 is a block diagram of a moving-picture encoder, according to the present invention;

FIG. 3 is a detailed block diagram of a bit rate controller of FIG. 2; and

FIG. 4 is a flow chart illustrating a method of encoding a video signal with a variable bit rate, according to the present invention.

### DETAILED DESCRIPTION OF THE INVENTION

Hereinafter, embodiments of the present invention will be described in detail with reference to the appended drawings.

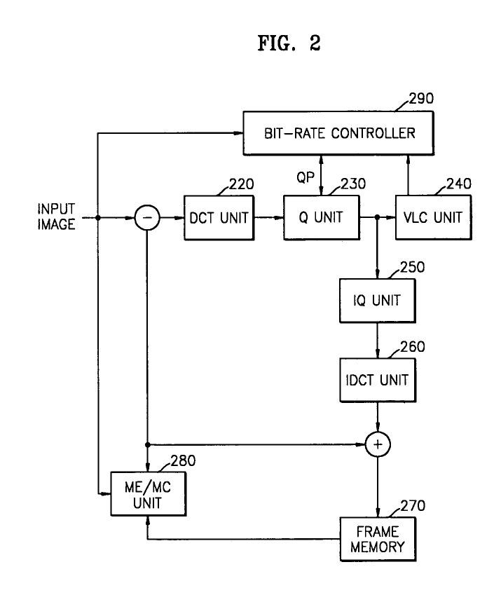

FIG. 2 is a block diagram of a moving-picture encoder, according to the present invention.

First, input moving picture data is divided into Group Of Picture (GOP) units.

Referring to FIG. 2, a Discrete Cosine Transform (DCT) unit 220 performs DCT on input image data of an 8×8 block unit, in order to obtain spatial redundancy of image data.

A quantization unit (Q) 230 quantizes the image data subjected to DCT by the DCT unit 220. The dequantization unit 250 dequantizes the image data quantized by the quantization unit 230.

An Inverse Discrete Cosine Transform (IDCT) unit 260 performs IDCT on the image data dequantized by the dequantization unit 250. A frame memory (FM) 270 stores the image data subjected to IDCT by the IDCT unit 260 in units of frames.

An ME/MC unit 280 estimates a movement vector (MV) and a Sum of Absolute Difference (SAD) for every macroblock, using image data of an input current frame and the image data of the previous frame stored in the frame memory 270, and performs movement compensation using the movement vector (MV).

A Variable Length Coding (VLC) unit 240 removes statistical redundancy of the quantized image data according to the movement vector (MV) estimated by the ME/MC unit 280.

A bit rate controller 290 generates a quantization parameter (QP) of a current frame, on the basis of the bit amount of the previous frame generated by the VLC unit 240 and the quantization parameter (QP) of the previous frame input from the quantization unit 230. Here, the quantization parameter (QP) of the current frame is calculated using the average complexity for each picture and the remaining bit amount of the corresponding picture.

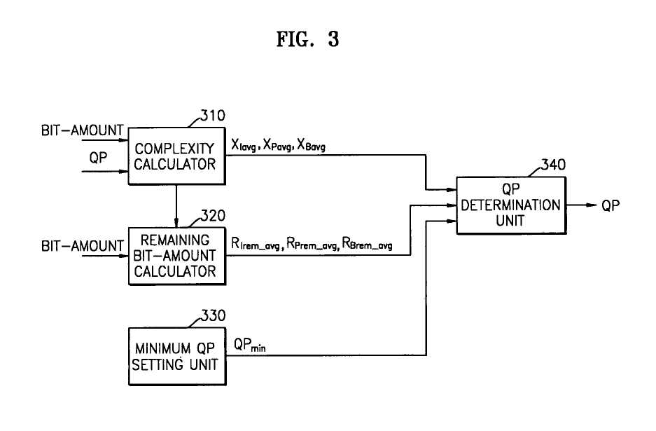

FIG. 3 shows a detailed block diagram of the bit rate controller of FIG. 2.

Referring to FIG. 3, the complexity calculator 310 calculates an average complexity for each picture (for example, I, P, or B picture) on the basis of the bit amount input from the VLC unit 240 and the quantization parameters input from the quantization unit. Here, an average complexity of the I picture is represented by X_{Iavg}, an average complexity of the P picture is represented by X_{Pavg}, and an average complexity of the B picture is represented by X_{Bavg}.

A remaining bit amount calculator 320 calculates an average remaining bit amount for each picture (for example, I, P, and B picture) using the bit amount input from the VLC 240. Here, the average remaining bit amount of the I picture is represented by R_{Irem}_{_{—}}_{avg}, the average remaining bit amount of the P picture is represented by R_{Prem}_{_{—}}_{avg}, and the average remaining bit amount of the B picture is represented by R_{Brem}_{_{—}}_{avg}.

A minimum QP setting unit 330 sets a minimum quantization parameter QPₘᵢₙ as an experimental value.

The QP decision unit 340 decides a quantization parameter for each picture, on the basis of the average complexities X_{Iavg}, X_{Pavg}, and X_{Bavg} for each picture, average remaining bit amounts R_{Irem}_{_{—}}_{avg}, R_{Prem}_{_{—}}_{avg}, and R_{Brem}_{_{—}}_{avg} for each picture, and the minimum quantization parameter QPₘᵢₙ, input from the complexity calculator 310, the remaining bit amount calculator 320, and the minimum QP setting unit 330.

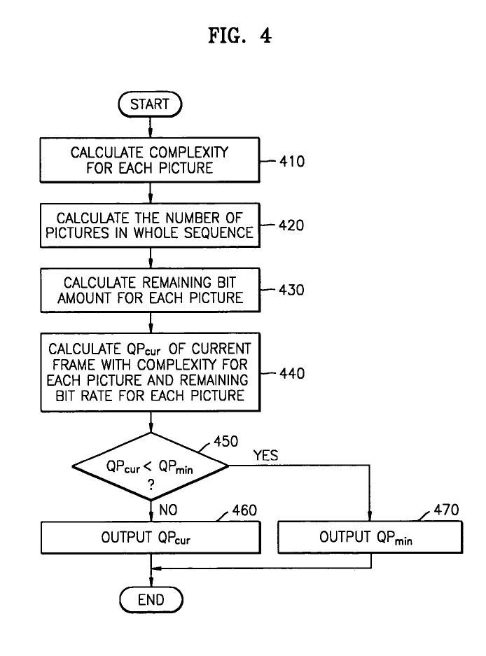

FIG. 4 is a flow chart illustrating a method of encoding a video signal with a variable bit rate, according to the present invention.

The encoding method according to the present invention is applied to a GOP including all picture types of I, B, and P pictures. Also, the present invention can be applied to the case of including only I and P pictures. The present invention processes pixels for each picture, unlike the conventional technique that processes pixels for each GOP. That is, a quantization parameter (QP) is decided for each picture, such as an I-picture, a P-picture, or a B-picture.

Referring to FIG. 4, first, an initial complexity for each picture is set (step 410). For example, initial complexities defined in the TM5 of the MPEG-2 can be used. The initial complexities for each picture defined in the TM5 of the MPEG-2 are represented as follows in equations 3.

$$\begin{matrix}{X}_{Iavg} = 160 \times \frac{bit\_rate}{115} \\ {X}_{Pavg} = 60 \times \frac{bit\_rate}{115} \\ {X}_{Bavg} = 42 \times \frac{bit\_rate}{115}\end{matrix} \qquad ( 3 )$$

Where, bit_rate represents a target bit rate units of bit/sec.

Also, the number N_I_rem of the I-pictures, the number N_B_rem of the B-pictures, and the number N_P_rem of the P-pictures in a whole sequence are calculated (step 420). If the length of the whole sequence is provided and the length of the GOP and the distance between the P-pictures are preset, the above calculation can be performed.

Then, if a current frame is an I-picture, a remaining bit amount for each picture is calculated in proportion to the complexities for each picture using the following Equations 4. Where, the remaining bit amount is a value obtained by subtracting a used bit amount from a target bit amount assigned initially for each picture. For example, in a case where in a whole sequence, the number of the I-pictures is 100, a current picture is a tenth I-picture, a target bit amount assigned to the whole sequence of I-pictures is 10000 bits, and 1000 bits are used for encoding the I-pictures up to a current time, a remaining bit amount R_{I}_{_{—}}ᵣₑₘ for the I-pictures is 9000 bits. As seen in Equations 4, the remaining bit amount for each picture is calculated at a start point of every GOP. Also, the remaining bit amount for each picture can be calculated in proportion to the complexity for each picture, as seen in Equations 4.

$$\begin{matrix}{R}_{I\_rem} = \frac{{X}_{Iavg} * N\_I \_rem}{{X}_{Lavg} * N\_I \_rem + {X}_{Pavg} * N\_P \_rem + {V}_{Bavg} * N\_B \_rem} * \\ ( {R}_{I\_rem} + {R}_{P\_rem} + {R}_{B\_rem} ) \\ {R}_{B\_rem} = \frac{{X}_{Bavg} * N\_B \_rem}{{X}_{Lavg} * N\_I \_rem + {X}_{Pavg} * N\_P \_rem + {V}_{Bavg} * N\_B \_rem} * \\ ( {R}_{I\_rem} + {R}_{P\_rem} + {R}_{B\_rem} ) \\ {R}_{P\_rem} = \frac{{X}_{Pavg} * N\_P \_rem}{{X}_{Lavg} * N\_I \_rem + {X}_{Pavg} * N\_P \_rem + {V}_{Bavg} * N\_B \_rem} * \\ ( {R}_{I\_rem} + {R}_{P\_rem} + {R}_{B\_rem} )\end{matrix} \qquad ( 4 )$$

Also, the remaining bit amount for each picture calculated by Equations 4 is represented by an average of a remaining bit amount for a frame for each picture using equation 5.

$${R}_{I\_rem \_avg} = \frac{{R}_{I\_rem}}{N\_I \_rem} , {R}_{P\_rem \_avg} = \frac{{R}_{P\_rem}}{N\_P \_rem} , \\ {R}_{B\_rem \_avg} = \frac{{R}_{B\_rem}}{N\_B \_rem} \qquad ( 5 )$$

Then, a quantization parameter QP_{cur} of a current frame is decided based on the complexity for each picture and the remaining bit amount for each picture (step 440).

If the current frame is an I-picture, the quantization parameter QP_{cur} for the current frame is calculated using Equation 6.

$${QP}_{CUR} = \frac{{X}_{Iavg}}{{R}_{I\_rem \_avg}} \qquad ( 6 )$$

If the current frame is a P-picture, the quantization parameter QPC_{cur} for the current frame is calculated using equation 7.

$${QP}_{CUR} = \frac{{X}_{Pavg}}{{R}_{P\_rem \_avg}} \qquad ( 7 )$$

If the current frame is an B-picture, the quantization parameter QP_{cur} for the current frame is calculated using Equation 8.

$${QP}_{CUR} = \frac{{X}_{Bavg}}{{R}_{B\_rem \_avg}} \qquad ( 8 )$$

Successively, the quantization parameter QP_{cur} of the current frame is compared with a predetermined minimum quantization parameter QPₘᵢₙ and a final quantization parameter QP is obtained (step 450). That is, if the quantization parameter QP_{cur} of the current frame is smaller than the minimum quantization parameter QPₘᵢₙ, the minimum quantization parameter is determined to be a final quantization parameter QP (step 470). If the quantization parameter QP_{cur} of the current frame is greater than the minimum quantization parameter QPₘᵢₙ, the quantization parameter QP_{cur} of the current frame is determined to be a final quantization parameter QP (step 480). The remaining bit amount calculated by Equation 4 in step 430 is calculated only for the I-picture indicating a start point of every GOP. If the current picture is not the I-picture indicating the start point of the GOP but is the B-picture or the P-picture, the remaining bit amount is a value obtained by subtracting the bit amount used in the previous corresponding B-picture or P-picture from the remaining bit amount of the corresponding picture. However, in some situations, the remaining bit amount can be calculated for every picture, using Equation 4.

Then, returning to step 410, the complexity of a current frame for each picture is calculated by multiplying the bit amount generated in the current frame by the quantization parameter QP_{cur} of the current frame. Successively, a new average complexity is obtained using the average complexity of the corresponding picture. If the current frame was the I-picture in step 420, the number N_I_rem of the I-pictures in the whole sequence decreases by one. If the current frame was the P-picture, the number N_P_rem of the P-pictures decreases by one. Also, if the current frame was the B-picture, the number N_B_rem of the B-pictures decreases by one. Accordingly, a quantization parameter QP for a new input frame is obtained in step 430.

The present invention may be embodied in a general purpose digital computer by running a program from a computer readable medium, including but not limited to storage media such as magnetic storage media (e.g., ROM's, floppy disks, hard disks, etc.), optically readable media (e.g., CD-ROMs, DVDs, etc.) and carrier waves (e.g., transmissions over the internet). The present invention may be embodied as a computer readable medium with a computer readable program code unit embodied therein for causing a number of computer systems connected via a network to affect distributed processing.

As described above, according to the present invention, it is possible to more closely approach a target bit amount by calculating a quantization parameter based on a remaining bit amount in a one-pass VBR method.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for encoding a video signal with a variable bit rate, the method comprising:
(a) calculating a complexity for each of a plurality of pictures on the basis of a bit amount and a quantization parameter of a previous frame;
(b) calculating a remaining bit amount for each picture in proportion to the complexity for each picture calculated in (a);
(c) calculating a quantization parameter of a current frame on the basis of the complexity for each picture and the remaining bit amount for each picture calculated in (b); and
(d) comparing the quantization parameter of the current frame calculated in (c) with a predetermined minimum quantization parameter and determining a final quantization parameter.

2. The method of claim 1, wherein the remaining bit amount for each picture is obtained by multiplying the complexity for each picture by a total bit amount of remaining frames for each picture.

3. The method of claim 1, wherein the remaining bit amount for each picture is decided as follows:
$$\frac{{X}_{Iavg} * N\_I \_rem}{{X}_{Lavg *} N\_I \_rem + {X}_{Pavg} * N\_P \_rem + {V}_{Bavg} * N\_B \_rem} * ( {R}_{I\_rem} + {R}_{P\_rem} + {R}_{B\_rem} )$$
for an I-picture;
$$\frac{{X}_{Bavg} * N\_B \_rem}{{X}_{Lavg *} N\_I \_rem + {X}_{Pavg} * N\_P \_rem + {V}_{Bavg} * N\_B \_rem} * ( {R}_{I\_rem} + {R}_{P\_rem} + {R}_{B\_rem} )$$
for a B-picture; and
$$\frac{{X}_{Pavg} * N\_P \_rem}{{X}_{Lavg *} N\_I \_rem + {X}_{Pavg} * N\_P \_rem + {V}_{Bavg} * N\_B \_rem} * ( {R}_{I\_rem} + {R}_{P\_rem} + {R}_{B\_rem} )$$
for a P-picture,
where, X_{Iavg} is an average complexity of the I picture, X_{Pavg} is an average complexity of the P picture, and X_{Bavg} is an average complexity of the B picture, N_I_rem, N_B_rem, and N_P_rem are the number of I-pictures, the number of B-pictures, and the number of P-pictures, in a whole sequence, respectively, and (R_{I}_{_{—}}ᵣₑₘ+R_{P}_{_{—}}ᵣₑₘ+R_{B}_{_{—}}ᵣₑₘ) is a remaining total bit amount.

4. The method of claim 1, wherein the quantization parameter of the current frame is obtained by dividing an average complexity for each picture by the remaining bit amount for each picture.

5. The method of claim 1, wherein in determining the final quantization parameter, the predetermined minimum quantization parameter is determined to be the final quantization parameter if the quantization parameter of the current frame is smaller than the predetermined minimum quantization parameter, and the quantization parameter of the current frame is determined to be the final quantization parameter if the quantization parameter of the current frame is greater than the predetermined minimum quantization parameter.

6. An apparatus for encoding a video signal, the apparatus comprising:
a discrete cosine transform (DCT) unit which performs DCT on input image data in units of macroblocks;
a bit rate controller which determines a quantization parameter of a current frame, on the basis of a bit amount for each picture and a complexity for each picture generated per frame;
a quantization unit which quantizes the image data subjected to DCT by the DCT unit according to the quantization parameter determined by the bit rate controller;
a dequantization unit which dequantize the image data quantized by the quantization means;
an Inverse Discrete Cosine Transform (IDCT) unit which performs IDCT on the image data dequantized by the dequantization unit;
a frame memory which stores the image data subjected to IDCT by the IDCT unit, in units of frames; and
a movement estimation and compensation unit which estimates a movement vector and a Sum of Absolute Difference (SAD) using image data of an input current frame and image data of an immediately preceding frame stored in the frame memory, and compensates for movement using the movement vector.

7. The apparatus of claim 6, wherein the bit rate controller comprises:
a complexity calculator which calculates the complexity for each picture on the basis of the bit amount of each frame in the picture and the quantization parameters;
a remaining bit amount calculator which calculates a remaining bit amount for each picture in proportion to the complexity calculated by the complexity calculator; and
a quantization parameter determination unit which determines the quantization parameter on the basis of the complexity for each picture and the remaining bit amount for each picture calculated by the complexity calculator and the remaining bit amount calculator.
